(19) United States
(12) Patent Application Publication
(10) Pub. No.: US 2025/0193923 A1
(43) Pub. Date: Jun. 12, 2025

(54) RELAY OPERATION WITH MULTIPLE AP COORDINATION

(71) Applicant: Samsung Electronics Co., Ltd., Suwon-si (KR)

(72) Inventors: Yue Qi, Plano, TX (US); Rubayet Shafin, Frisco, TX (US); Peshal Nayak, Plano, TX (US); Boon Loong Ng, Plano, TX (US); Vishnu Vardhan Ratnam, Frisco, TX (US)

(21) Appl. No.: 18/961,317

(22) Filed: Nov. 26, 2024

Related U.S. Application Data
(60) Provisional application No. 63/607,002, filed on Dec. 6, 2023.

(51) Int. Cl. H04W 74/04; H04W 88/04; H04W 88/08

(52) U.S. Cl. CPC H04W 74/04; H04W 88/04; H04W 88/08

(57) ABSTRACT

A relay station (STA) in a wireless network, associates with a first access point (AP) on the first channel; associates with a second AP on the first channel; performs a first communication on the first channel with the first AP in a first service period; and performs a second communication on the first channel with the second AP in a second service period, wherein the first communication is a relaying operation between a first STA and the first AP and the second communication is a relaying operation between a second STA and the second AP.

### CROSS-REFERENCE TO RELATED APPLICATION(S)

This application claims the benefit of priority from U.S. Provisional Application No. 63/607,002, entitled “RELAY OPERATION WITH MULTIPLE AP COORDINATION,” filed Dec. 6, 2023, which is incorporated herein by reference in its entirety.

### TECHNICAL FIELD

This disclosure relates generally to a wireless communication system, and more particularly to, for example, but not limited to, relay operation in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a relay station (STA) in a wireless network. The relay STA comprises a memory and a processor coupled to the memory. The processor is configured to cause associating with a first access point (AP) on a first channel. The processor is configured to cause associating with a second AP on the first channel. The processor is configured to cause performing a first communication on the first channel with the first AP in a first service period. The processor is configured to cause performing a second communication on the first channel with the second AP in a second service period.

In some embodiments, the first communication is a first relay operation between a first STA and the first AP, and the second communication is a second relay operation between a second STA and the second AP.

In some embodiments, the first communication is a relay operation between a first STA and the first AP, and the second communication is an uplink or downlink operation with a second AP.

In some embodiments, the first communication is a relay operation between a first STA and the first AP, and the second communication is a peer-to-peer communication with a second STA.

In some embodiments, the processor is further configured to cause: associating with a third AP on a second channel; and performing a third communication on the second channel with the third AP in a third service period.

In some embodiments, the processor is further configured to cause: performing a third communication on the first channel with a third AP in a third service period, wherein the first AP and the third AP participate in a multi-AP coordination, and the first AP shares information associated with the relay STA with the third AP.

In some embodiments, the processor is further configured to cause: negotiating the first service period with the first AP; and negotiating the second service period with the second AP, wherein the second service period does not overlap with the first service period.

In some embodiments, the first service period and the second service period are coordinated between the first AP and the second AP.

In some embodiments, the first service period and the second service period are coordinated by a controller for multiple access points.

In some embodiments, the processor is further configured to cause: transmitting, to the first AP on the first channel, a first frame requesting a channel switch to a second channel; receiving, from the first AP on the first channel, a second frame indicating acceptance of the channel switch; transmitting, to the first STA on the first channel, a third frame requesting the channel switch to the second channel; receiving, from the first STA on the first channel, a fourth frame indicating acceptance of the channel switch; and performing a relay operation on the second channel between the first AP and the first STA.

An aspect of the disclosure provides a method performed by a relay station (STA) in a wireless network. The method comprises associating with a first access point (AP) on a first channel. The method comprises associating with a second AP on the first channel. The method comprises performing a first communication on the first channel with the first AP in a first service period. The method comprises performing a second communication on the first channel with the second AP in a second service period.

In some embodiments, the first communication is a first relay operation between a first STA and the first AP, and the second communication is a second relay operation between a second STA and the second AP.

In some embodiments, the first communication is a relay operation between a first STA and the first AP, and the second communication is an uplink or downlink operation with a second AP.

In some embodiments, the first communication is a relay operation between a first STA and the first AP, and the second communication is a peer-to-peer communication with a second STA.

In some embodiments, the method further comprises associating with a third AP on a second channel and performing a third communication on the second channel with the third AP in a third service period.

In some embodiments, the method further comprises performing a third communication on the first channel with a third AP in a third service period, wherein the first AP and the third AP participate in a multi-AP coordination, and the first AP shares information associated with the relay STA with the third AP.

In some embodiments, the method further comprises negotiating the first service period with the first AP and negotiating the second service period with the second AP, wherein the second service period does not overlap with the first service period.

In some embodiments, the first service period and the second service period are coordinated between the first AP and the second AP.

In some embodiments, the first service period and the second service period are coordinated by a controller for multiple access points.

In some embodiments, the method further comprises: transmitting, to the first AP on the first channel, a first frame requesting a channel switch to a second channel; receiving, from the first AP on the first channel, a second frame indicating acceptance of the channel switch; transmitting, to the first STA on the first channel, a third frame requesting the channel switch to the second channel; receiving, from the first STA on the first channel, a fourth frame indicating acceptance of the channel switch; and performing a relay operation on the second channel between the first AP and the first STA.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example scenario of relay operation in accordance with an embodiment.

FIG. 5 shows an example scenario of relay operation where the APs are coordinated by an MCC in accordance with an embodiment.

FIG. 6 shows an example scenario of relay operation where the APs and the relay are coordinated by an MCC in accordance with an embodiment.

FIG. 7 shows an example of relay transmissions in accordance with an embodiment.

FIG. 8 shows an example of relaying operations in accordance with an embodiment.

FIG. 9 shows an example scenario of a channel switch in accordance with an embodiment.

FIG. 10 shows a flowchart of the operation of a relay (STA) in accordance with an embodiment of this invention.

FIG. 11 shows a flowchart of the operation of an AP in accordance with an embodiment of this invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHZ, 5 GHZ, 6 GHZ or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs.

Multiple Input Multiple Output (MIMO) technology represents one such approach that has emerged as a popular technique. MIMO has been adopted in several wireless communications standards such as 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

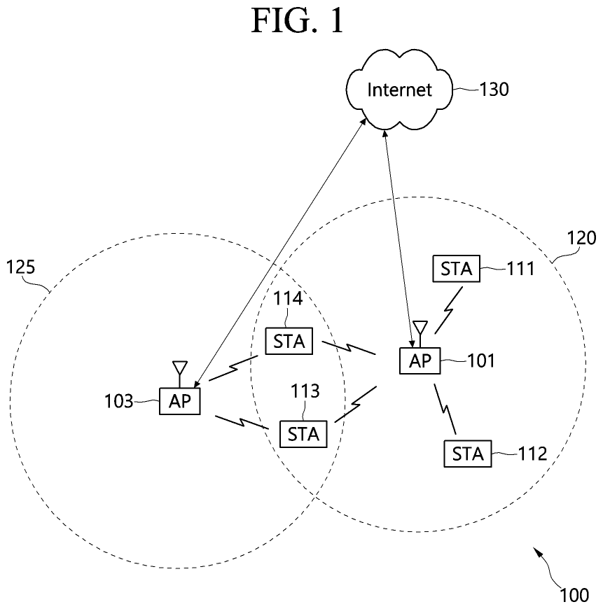

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs and variations in the radio environment associated with natural and man-made obstructions.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

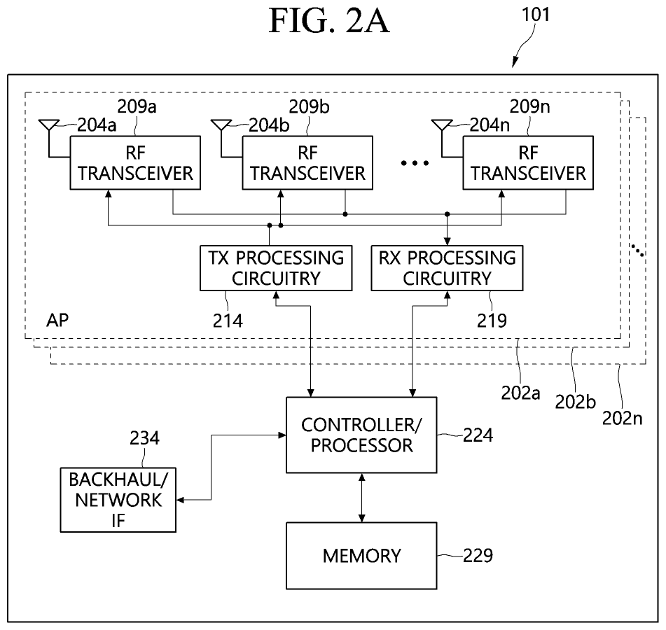

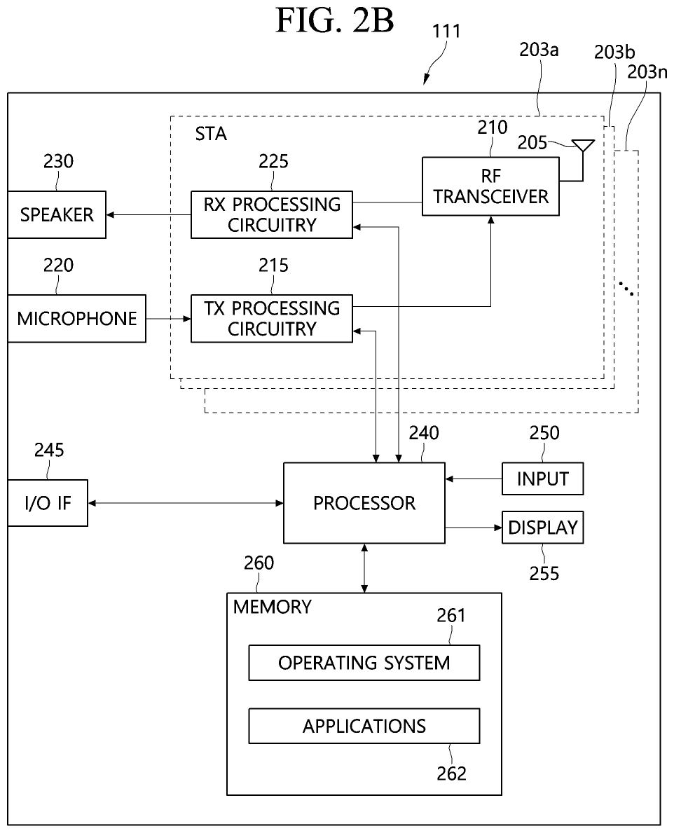

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example of STA 111 in according to this disclosure. The embodiment of the STA 111 shown in FIG. 2B is for illustrative purposes only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

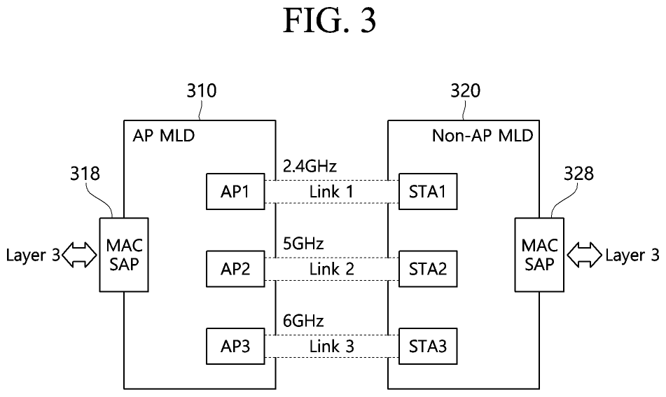

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.”

Extending coverage and improving connectivity in access points (AP) has been important in WLAN network. A relay plays a crucial role in extending coverage and improving connectivity for APs. The relay acts as intermediaries that receive and transmit signals between APs, for example a main router, and devices in areas with weak reception. Relays may be positioned in reference to an AP to extend the AP's coverage range. This extension of coverage may be in the form of reaching devices farther away or reaching devices in areas that lack connection for geographical reasons. This is especially important in larger homes or malls where the signals of the APs might not reach every corner. Relays help ensure a seamless browsing and streaming experience, promoting better productivity and user satisfaction.

Multiple Access Point (MAP) is considered as a key technology in IEEE 802.11bn standard. In a MAP network same relay resources may be shared by multiple APs. However, the role of a relay, the transmission protocols for a relay and the traffic steering for a relay in a MAP network are unclear.

Range extension may be necessary for an AP with a coverage range. The coverage range may suffer from poor connection or an inability to connect the more distant the STA trying to connect is from the AP. A coverage range of an AP may be extended by using resources of, for example, a relay to reach the STA. If a STA requires use of the AP but is outside of the AP's coverage range, then the AP may use the resources of a relay to bring the STA within the AP's extended coverage range.

In some embodiments, a Multiple Access Point (MAP) network may allow for same relay resources to be shared by multiple APs. In this disclosure, the architecture, transmission protocols, and traffic steering solutions for a relay with MAP are presented.

In some embodiments, the architecture of relay serving MAPs may be defined, for example and without limitation, as in the following three embodiments. The first embodiment of architecture features independent APs. The second embodiment of architecture features coordinated and controlled APs by a MAP control center (MCC). The third embodiment of architecture features coordinated and controlled APs and relay by a MCC.

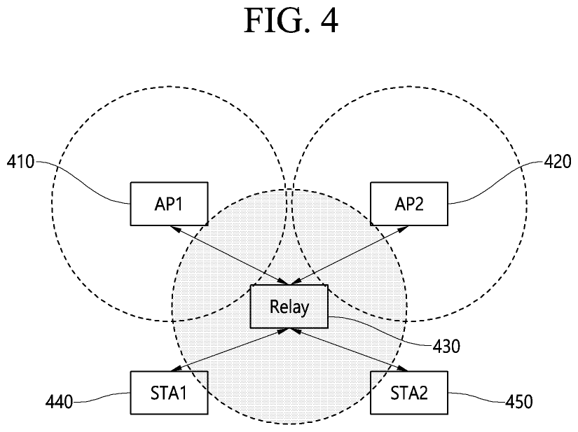

FIG. 4 shows an example scenario of relay operation in accordance with an embodiment.

Referring to FIGS. 4, AP1 410 and AP2 420 are independent. STA1 440 and STA2 450 are both not within the coverage range of AP1 410 or AP2 420. The relay 430 is within coverage range of AP1 410 and AP2 420. STA1 440 and STA2 450 are both within coverage range of the relay 430. The relay 430 may perform or assist the operations of AP1 410 and STA1 440 and AP2 420 and STA2 450 independently. The relay 430 may use multiple relay transmission sets. A relay transmission set includes a source device, the relay and a destination device. The relay transmission set describes the parameters of a relay operation. In a relay operation, the relay may receive, from the source device, a transmission and may subsequently transmit that the received transmission to the destination device. In an embodiment, the relay 430 may operate in a first transmission set including AP1 410, the relay 430 and STA1 440. The relay 430 may also operate in a second transmission set including AP2 420, the relay 430 and STA2 450.

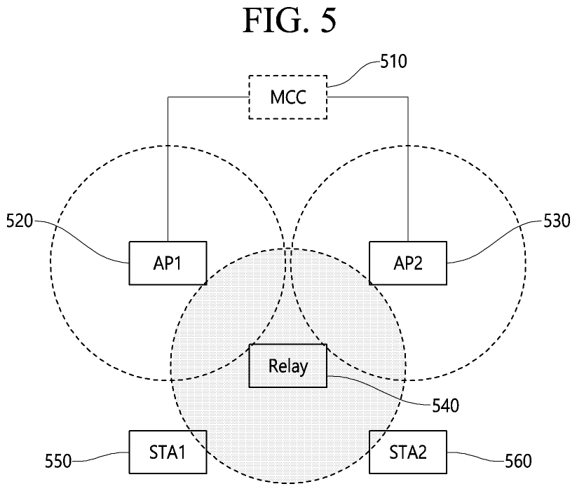

FIG. 5 shows an example scenario of relay operation where the APs are coordinated by an MCC in accordance with an embodiment.

Referring to FIG. 5, the MCC 510 coordinates and controls AP1 520 and AP2 530. STA1 550 and STA2 560 are not within the coverage range of AP1 520 or AP2 530. The relay 540 is within coverage range of AP1 520 and AP2 530. STA1 550 and STA2 560 are both within coverage range of the relay 540. The MCC 510 may, through coordination of AP1 520 and AP2 530, coordinate the relay operations of relay 540 to provide additional convenience to relay 540's resource sharing. In one embodiment, the MCC 510 may coordinate AP1 520 and AP2 530 to have AP1 520 associated with the relay 540 and share AP2 530 rather than have both AP1 520 and AP2 530 associate with the relay 540.

In FIG. 5, AP1 520 may share another AP with either STA1 550 or STA2 560 or both through the relay 540. An AP may share another AP using a relay by providing a STA with the requisite information about the other AP for the STA to communicate with the other AP through the relay. The STA may then transmit its communication to the relay with the other AP as the destination device. In one embodiment, AP2 530 may be the other AP.

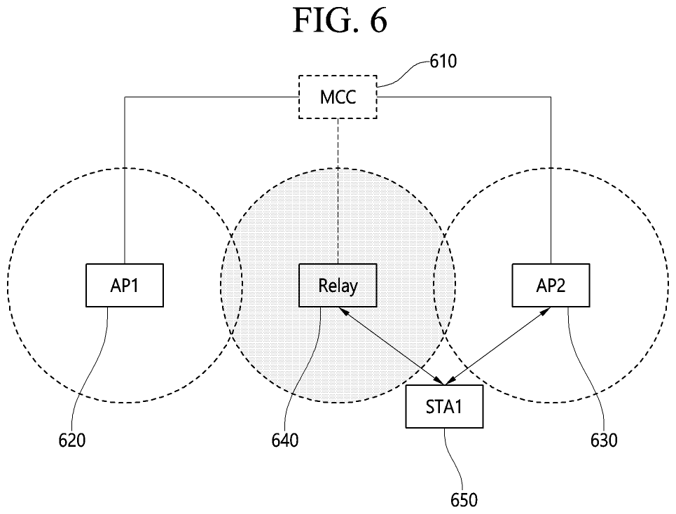

FIG. 6 shows an example scenario of relay operation where the APs and the relay are coordinated by an MCC in accordance with an embodiment.

Referring to FIG. 6, the MCC 610 coordinates and controls AP1 620, AP2 630, and the relay 640. STA1 650 is not within coverage range of AP1 620. The relay 640 is within coverage range of AP1 620 and AP2 630. STA1 650 is within coverage range of the relay 640 and AP2 630.

In FIG. 6, a managed network may comprise APs and a relay which are controlled by an MCC. The MCC 610 may coordinate AP1 620 to transmit frames through the relay 640 to STA1 650 or coordinate AP2 630 to transmit frames directly to STA1 650.

In some embodiments, the transmission protocols for relay, including discovery, setup, (re) association, and teardown procedure, may be provided.

In some embodiments, a relay may be associated with an AP. The relay may comprise a basic service set identifier (BSSID) that indicates that the AP is associated with the relay. The relay's association with an AP may be extended. In some embodiments, a relay may be associated with multiple APs. The relay may independently set up, (re) associate, and teardown with one or more APs. A relay may broadcast a discovery frame to indicate its existence to the nearby devices. A relay may indicate if the relay possesses the capability to support multiple APs or multiple non-AP STAs.

In some embodiments, one or more APs and a relay may set up on the same channel, or different channels.

In some embodiments, a relay may be associated with a sharing AP. The sharing AP may share the relay with one or more shared APs. In some embodiments, a relay and a shared AP may be coordinated by an MCC. The relay may also associate, set up, and teardown with a sharing AP. The sharing AP may then broadcast via fronthaul or backhaul the existence of the relay to one or more shared APs. An interested shared AP may then share the relay and use the relay resources.

In some embodiments, a sharing AP may include the relay resource element in a frame, for example and without limitation, during MAP coordination procedure. The frame may be, for example and without limitation, a beacon frame, probe request/response frame, or MAP coordination request/response frames.

In some embodiments, the relay resource element may comprise relay ID, BSSID, the sharing AP's ID, and user information list.

Table 1 below shows relay resource elements in accordance with an embodiment.

TABLE 1

| Information Field | Description |
|---|---|
| Relay ID(s) | Indicate the ID(s) of relay resources. |
| BSSID(s) | Indicate the BSSID(s) that relay resources are in |
| | operation within. |
| AP ID(s) | Indicate the (sharing) AP ID(s) that relay |
| | resources are associated with. |
| User Info List | Indicate the information of destination STA(s) |
| | that requests relay support via the relay |
| | resources, operation bands and/or links |
| Operating Band/Link | Indicate the potential operating bands and/or |
| | links. |

In some embodiments, a relay may associate with multiple APs in different resources. A relay may associate, set up, or teardown with multiple APs performing transmission in different time/frequency/code/spatial resources.

In some embodiments, a relay may associate with one AP set, for example, a set of coordinated MAP group.

In some embodiments, a relay may associate, set up, or teardown with a group of APs with a group ID. In an embodiment, a relay may be used within a group of APs. The group of APs may be a MAP group including more than one AP, for example AP1 and AP2. The group of APs may have a MAP group ID that indicates if the AP is a member of the MAP group. The MAP group may have an upper MAC of an AP multi-link device (MLD). The upper MAC of an AP MLD may provide the MAP group with assistance in organization of the group of APs, for example scheduling transmissions from the APs. The upper MAC of an AP MLD may determine which AP to associate with the relay based on the link that the relay is operating on. The relay may be associated with one or multiple AP(s) by receiving the information of the APs. The APs information may be ID, operating bands/links. An AP in the group of APs may share the relay with other APs in the group of APs allowing the other APs to use the relay resources.

In some embodiments, traffic steering solutions for different architectures may be defined in the following embodiments.

In some embodiments, traffic steering may be necessary for relay resource sharing. AP1 and AP2 are independent. AP1 and AP2 are operating on the same channel. A relay may manage the transmission between multiple APs while APs are operating on the same channel. NAV settings and triggering frames may handle traffic management. In one embodiment, a second AP detects a channel is busy while a first AP is transmitting. The second AP may wait and contend the channel later.

In some embodiments, a relay may initiate a trigger frame for any AP for relay transmission. A trigger frame may comprise a request to send (RTS)/clear to send (CTS), or multi-user (MU) RTS/CTS.

In some embodiments, a relay may negotiate with APs for different service periods. Different service periods may refer to different target wait time (TWT) service periods (SPs). The relay negotiating with APs for different service periods may also be beneficial for relay power save. A relay may not have power saving requirements of its own. A relay may need to know of a destination STA(s)′ power save (PS) (mode) schedules. A relay may coordinate AP(s) or destination STA(s), other relay(s), and initiate some common PS schedule(s). Therefore, a TWT concept may be extended.

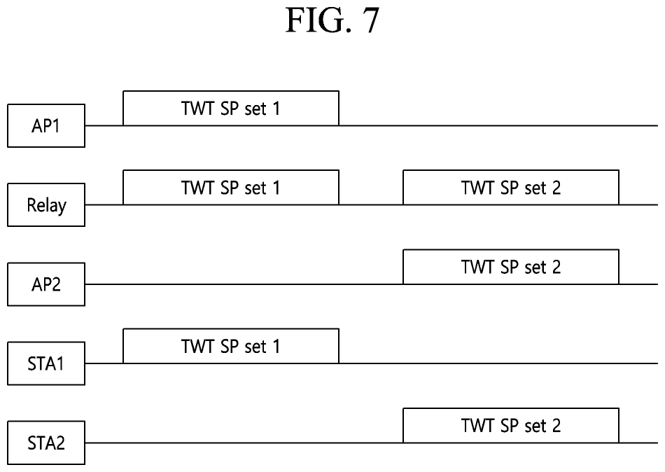

FIG. 7 shows an example of relay transmissions in accordance with an embodiment.

Referring to FIG. 7, TWT SP set 1 is established among AP1, Relay, and STA1 during a first time period, while TWT SP set 2 is established among AP2, Relay and STA2 during a second time period. The first time period and the second time period do not overlap. AP1 and AP2 are independent and operate on the same channel. As illustrated, AP1 and STA1 communicate using the relay in TWT SP set 1, while AP2 and STA2 communicate using the relay in TWT SP set 2. In FIG. 7, Relay may perform relay transmissions with multiple APs during different TWT SPs.

In some embodiments, a relay may use different power save time windows for relaying operations and uplink (UL), downlink (DL), and peer-to-peer (P2P) operations, if a relay itself has a power save requirement.

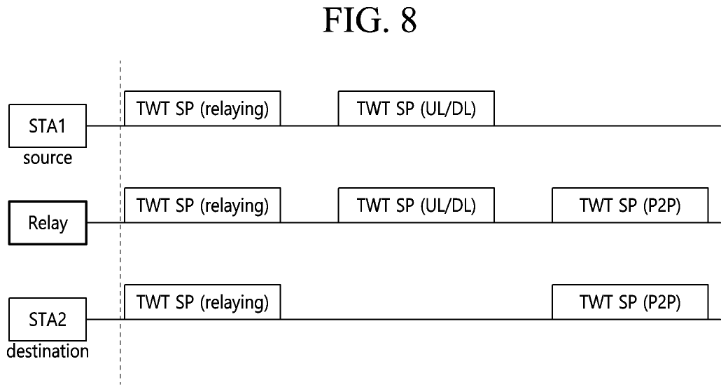

FIG. 8 shows an example of relaying operations in accordance with an embodiment.

Referring to FIG. 8, a first TWT SP set is established among STA1, Relay, and STA2 during a first time period, while a second TWT SP set is established between STA1 and Relay during a second time period, and a third TWT SP set is established between Relay and STA2 during a third time period. The first time period, the second time period, and the third time period do not overlap. TWT SPs belonging to each respective TWT SP set are aligned with each other. AP1 and AP2 are independent and operate on the same channel. As illustrated STA1 is the source STA for the relaying operation. STA2 is the destination STA for the relaying operation. Relay performs a relay operation between STA1 and STA2 during the first TWT SP set. In the second TWT SP set, Relay performs UL/DL operations with STA1. In an embodiment, STA1 may be an AP. In the third TWT SP set, Relay performs a peer-to-peer (P2P operation with STA2). In an embodiment STA2 may be a peer STA. In FIG. 8, Relay may use different time windows for different operations. In some embodiments, operations may be extended for harmonizing PS schedules of relays and STAs.

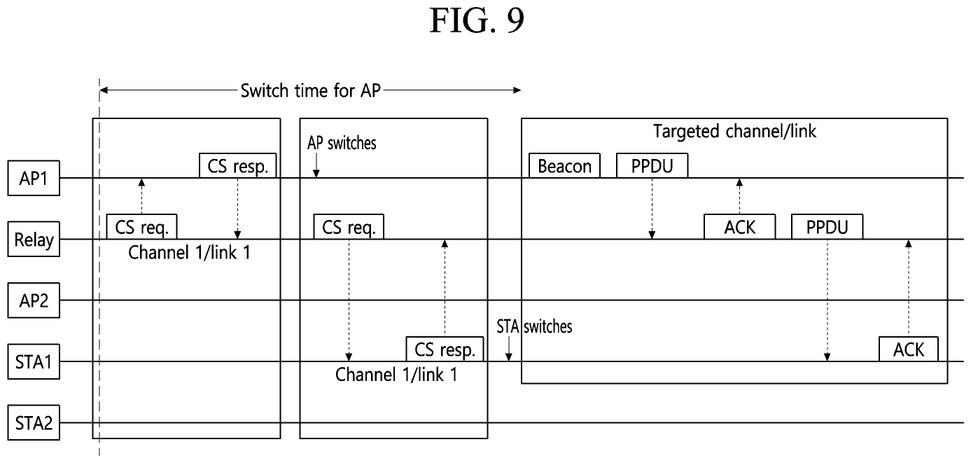

FIG. 9 shows an example scenario of a channel switch operation in accordance with an embodiment.

Referring to FIG. 9, AP1, Relay and STA1 are engaged in transmissions on channel 1 (link 1). Relay on channel 1 transmits a channel switch (CS) request to AP1. In an embodiment, the CS request may indicate target channel. In response, AP1 transmits a CS response to Relay. Subsequently, AP1 switches the channel to the targeted channel. In an embodiment, the target channel may be determined at the discretion of AP1. Similarly, Relay on channel 1 transmits a CS request to STA1. In response, STA1 transmits a CS response to Relay. Subsequently, STA1 then switches the channel to the target channel. Afterwards, AP1 transmits a beacon frame. Subsequently, AP1 transmits a physical layer protocol data unit (PPDU) to Relay. In response, Relay transmits an acknowledgement (ACK) to AP1. Subsequently Relay transmits the PPDU to STA1. In response, STA1 transmits an ACK to Relay. In some embodiments, an AP may hold beaconing until the destination STA also finishes the channel/link/operation switch. In an embodiment, the beacon frame may include in its signal a padding field including the relaying/delaying time. In an embodiment, the response Timeout may be extended, providing more time for Relay perform the CS operation. In an embodiment, an AP may also initiate a channel switch request. An AP may transmit or forward a channel switch request frame.

In some embodiments, other operations, mode switch-procedures and control frames may provide information about relaying/delaying time or increased time limits for response. These operations, procedures and control frames may include but are not limited to RTS, CTS, other kinds of trigger frames, ACK, MLD operation mode, and NSS.

In some embodiments, a channel/link/operation mode switch request frame may include the items found in Table 2.

TABLE 2

| Information Field | Description |
|---|---|
| Reason Code | This subfield indicates the reason why STA |
| | (relay, non-AP STA, AP STA, etc.,) initiates |
| | the switch. Possible codes can be “channel/link |
| | busy”, “unreachable”, “mode unavailable”, |
| | “mode not exist”, etc. |
| Targeted Channel List | This subfield indicates the potential useable |
| | targeted channel list. |
| Targeted Channel | This subfield indicates the potential useable |
| | targeted channel. |
| Targeted Link List | This subfield indicates the potential useable |
| | targeted link list. |
| Targeted Link | This subfield indicates the potential useable |
| | targeted link. |
| Targeted Mode List | This subfield indicates the potential useable |
| | targeted mode list, for example, EMLSR, |
| | EMLMR, etc. |
| Targeted Mode | This subfield indicates the potential useable |
| | targeted mode. |
| User Info List | Indicates the destination STA(s) that are |
| | intended to switch. |

Table 2 shows an Information field in the channel switch request frame in accordance with an embodiment.

In some embodiments, a response frame may also include some of the information in Table 3 as well as the information in Table 2.

TABLE 3

| Information Field | Description |
|---|---|
| Response | This subfield indicates if the request is confirmed |
| | or not. If the STA agrees to switch channel, |
| | responding with “Accept”; if the STA suggests |
| | another channel, responding with “alternate”, |
| | otherwise, the STA may reply with “reject”. |
| Alternate Channel(s) | Indicate any suggested channel(s) if responding |
| | with “alternate”. |

Table 3 shows additional elements in an Information field in the channel switch response frame in accordance with an embodiment.

In some embodiments, a relay may manage a transmission assisted by coordinated APs. Coordinated APs may assist a Relay in managing a transmission by reducing the complexity of the operations involved in the transmission. If a coordinated AP1 is already associated with the relay, then a coordinated AP2 shall not need to perform any association operations with Relay in order for Relay to manage a transmission of AP2. Coordinated APs may also coordinate in backhaul. The relay may avoid having to perform multiple negotiations with the coordinated APs.

In some embodiments, an AP may be part of a MAP network. The MAP network may be coordinated by an MCC. The AP may be in a transmission set with a relay. The AP may notify the relay about the MAP network being coordinated during relay procedures. The relaying procedures may include, without limitation, discovery and setup. The relay may then know the coordination mode of the MAP network, for example and without limitation C-TDMA. The relay may then have information that assists operations for other relay transmission sets.

In some embodiments, a coordinated relay may manage a transmission assisted by coordinated APs. The coordinated relay and coordinated APs are coordinated by an MCC. Coordinated APs may assist the coordinated relay in managing a transmission by reducing the complexity of the operations involved in the transmission as described above. Coordinated APs may also coordinate in backhaul. The relay may avoid having to perform multiple negotiations with the coordinated APs.

In some embodiments, an AP may be part of a MAP network. The MAP network may be coordinated by an MCC. The AP may be in a transmission set with a relay. The relay may also be coordinated with the MAP network by the same MCC. The relay may be notified about the relay MAP network being coordinated during relay procedures. The relaying procedures may include, without limitation, discovery and setup. The relay may then know the coordination mode of the MAP network, for example and without limitation C-TDMA. The relay may then have information that assists operations for other relay transmission sets.

In some embodiments, a relay may be an MLD relay. The MLD relay may still share relay resources with more than one APs even if those APs are operating on different channels. The MLD relay may be capable of using different links for steering traffic in different directions. The MLD relay may also be a dual band support device, capable of using different bands/channels for operating with different relay transmissions sets.

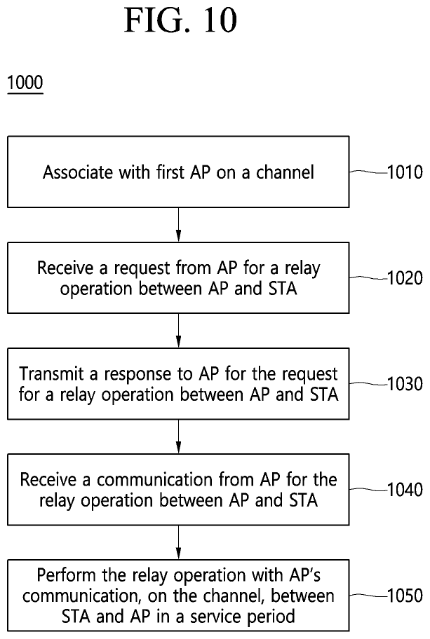

FIG. 10 shows an example process 1000 of a relay operation in accordance with an embodiment. Although one or more operations are described or shown in particular sequential order, in other embodiments the operations may be rearranged in a different order, which may include performance of multiple operations in at least partially overlapping time periods. The process 1000 may be performed in a relay STA.

In FIG. 10, a relay STA-side procedure for a relay STA responding to a request for a relay operation by an AP. FIG. 10 is exemplary and shall not be deemed to constitute a limitation on this disclosure.

The process 1000 begins in operation 1010. In operation 1010, relay STA associates with AP on a channel. Then, the process 1000 proceeds to operation 1020.

In operation 1020, relay STA receives a request from AP for a relay operation between AP and a STA. Then, the process 1000 proceeds to operation 1030.

In operation 1030, relay STA transmits a response to AP for the request for a relay operation between AP and STA. Then, the process 1000 proceeds to operation 1040.

In operation 1040, relay STA receives a communication from AP for the relay operation between AP and STA. Then, the process 1000 proceeds to operation 1050.

In operation 1050, relay STA performs the relay operation with AP's communication, on the channel, between STA and AP in a service period. Then, the process 1000 ends.

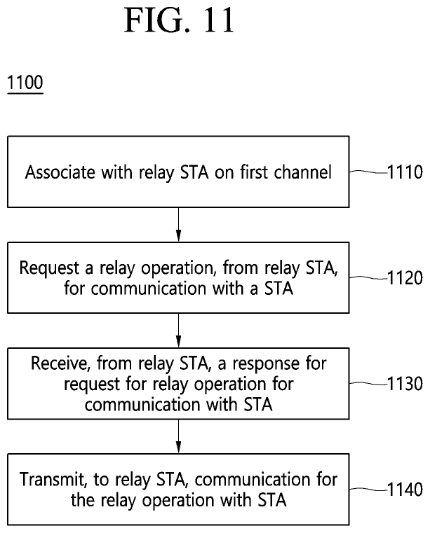

FIG. 11 shows an example process 1100 of an AP operation in accordance with an embodiment. Although one or more operations are described or shown in particular sequential order, in other embodiments the operations may be rearranged in a different order, which may include performance of multiple operations in at least partially overlapping time periods. The process 1000 may be performed in a relay STA.

In FIG. 11, an AP-side procedure for an AP requesting a relay operation from a relay STA. FIG. 11 is exemplary and shall not be deemed to constitute a limitation on this disclosure.

In operation 1110, AP associates with relay STA on a channel. Then, the process 1100 proceeds to operation 1120.

In operation 1120, AP requests a relay operation from relay STA for communication with a STA. Then, the process 1100 proceeds to operation 1130.

In operation 1130, AP receives, from relay STA, a response for the request for relay operation for communication with STA. Then, the process 1100 proceeds to operation 1140.

In operation 1140, AP transmits, to relay STA, communication for the relay operation with STA. Then, the process 1100 ends.

According to various embodiments, a relay allocating resources according to transmission protocols and traffic steering for a MAP network provides extended coverage for APs and provides enhanced reliability by providing for relay operations in the MAP network as well as utilizing the availability of multiple APs to create redundancies in case of failure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A relay station (STA) in a wireless network, comprising:
a memory; and
a processor coupled to the memory, the processor configured to cause:
associating with a first access point (AP) on a first channel;
associating with a second AP on the first channel;
performing a first communication on the first channel with the first AP in a first service period; and
performing a second communication on the first channel with the second AP in a second service period.

2. The relay STA of claim 1, wherein the first communication is a first relay operation between a first STA and the first AP, and the second communication is a second relay operation between a second STA and the second AP.

3. The relay STA of claim 1, wherein the first communication is a relay operation between a first STA and the first AP, and the second communication is an uplink or downlink operation with a second AP.

4. The relay STA of claim 1, wherein the first communication is a relay operation between a first STA and the first AP, and the second communication is a peer-to-peer communication with a second STA.

5. The relay STA of claim 1, wherein the processor is further configured to cause:
associating with a third AP on a second channel; and
performing a third communication on the second channel with the third AP in a third service period.

6. The relay STA of claim 1, wherein the processor is further configured to cause:
performing a third communication on the first channel with a third AP in a third service period, wherein the first AP and the third AP participate in a multi-AP coordination, and the first AP shares information associated with the relay STA with the third AP.

7. The relay STA of claim 1, wherein the processor is further configured to cause:
negotiating the first service period with the first AP; and
negotiating the second service period with the second AP, wherein the second service period does not overlap with the first service period.

8. The relay STA of claim 1, wherein the first service period and the second service period are coordinated between the first AP and the second AP.

9. The relay STA of claim 1, wherein the first service period and the second service period are coordinated by a controller for multiple access points.

10. The relay STA of claim 1, wherein the processor is further configured to cause:
transmitting, to the first AP on the first channel, a first frame requesting a channel switch to a second channel;
receiving, from the first AP on the first channel, a second frame indicating acceptance of the channel switch;
transmitting, to the first STA on the first channel, a third frame requesting the channel switch to the second channel;
receiving, from the first STA on the first channel, a fourth frame indicating acceptance of the channel switch; and
performing a relay operation on the second channel between the first AP and the first STA.

11. A method performed by a relay station (STA) in a wireless network, comprising:
associating with a first access point (AP) on a first channel;
associating with a second AP on the first channel;
performing a first communication on the first channel with the first AP in a first service period; and
performing a second communication on the first channel with the second AP in a second service period.

12. The method of claim 11, wherein the first communication is a first relay operation between a first STA and the first AP, and the second communication is a second relay operation between a second STA and the second AP.

13. The method of claim 11, wherein the first communication is a relay operation between a first STA and the first AP, and the second communication is an uplink or downlink operation with a second AP.

14. The method of claim 11, wherein the first communication is a relay operation between a first STA and the first AP, and the second communication is a peer-to-peer communication with a second STA.

15. The method of claim 11, further comprising:
associating with a third AP on a second channel; and
performing a third communication on the second channel with the third AP in a third service period.

16. The method of claim 11, further comprising:
performing a third communication on the first channel with a third AP in a third service period, wherein the first AP and the third AP participate in a multi-AP coordination, and the first AP shares information associated with the relay STA with the third AP.

17. The method of claim 11, further comprising:
negotiating the first service period with the first AP; and
negotiating the second service period with the second AP, wherein the second service period does not overlap with the first service period.

18. The method of claim 11, wherein the first service period and the second service period are coordinated between the first AP and the second AP.

19. The method of claim 11, wherein the first service period and the second service period are coordinated by a controller for multiple access points.

20. The method of claim 11, further comprising:
transmitting, to the first AP on the first channel, a first frame requesting a channel switch to a second channel;
receiving, from the first AP on the first channel, a second frame indicating acceptance of the channel switch;
transmitting, to the first STA on the first channel, a third frame requesting the channel switch to the second channel;
receiving, from the first STA on the first channel, a fourth frame indicating acceptance of the channel switch; and
performing a relay operation on the second channel between the first AP and the first STA.
